(19) United States
(12) Patent Application Publication
(10) Pub. No.: US 2013/0216990 A1
(43) Pub. Date: Aug. 22, 2013

(54) METHOD AND SYSTEM FOR INTERACTIVE LIVE WEBCAM PHYSICAL ACTIVITY CLASSES

(71) Applicant: Powhow Inc., (US)

(72) Inventors: Viva Chu, Old Greenwich, CT (US); Victor Chu, New York, NY (US)

(73) Assignee: Powhow Inc., New York, NY (US)

(21) Appl. No.: 13/767,576

(22) Filed: Feb. 14, 2013

Related U.S. Application Data
(60) Provisional application No. 61/599,518, filed on Feb. 16, 2012.

(51) Int. Cl. G09B 5/06

(52) U.S. Cl. CPC G09B 5/065
USPC 434/247

(57) ABSTRACT

Systems and methods are provided for interactive live webcam physical activity classes. A system analyzes each live video stream of physical activity learning sent from web cams to a user interface. The user interface is associated with a webcam that sends a live video stream of physical activity instruction to user interfaces associated with the web cams. The system sends the analysis of one of the live video streams of physical activity learning to a corresponding web cam.

### CLAIM OF PRIORITY

This application claims the benefit of U.S. Provisional Patent Application 61/599,518 entitled SYSTEM FOR MANAGING LIVE WEBCAM CLASSES, by Viva Chu, et al., filed Feb. 16, 2012 (Attorney Docket No. 1414.04 PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### INTERACTIVE LIVE WEBCAM PHYSICAL ACTIVITY CLASSES

One or more implementations relate generally to webcam classes.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Interactive live webcam classes provide for two-way broadcasts of video and audio to and from instructors and students. Many systems provide the same general interactive live webcam classroom while offering various improvements and differentiation from the general interactive live webcam classroom. Such interactive live webcam classrooms are widely known for lectures and speaking-based educational classrooms that mimic or broadcast in-person academic classes. This type of learning is limited to lecturing and on-screen computer demonstrations by instructors for student note taking, playback, and memorization.

Physical activities-based classes include, but are not limited to, cooking, fitness, athletic, health, arts, crafts, do-it-yourself, renovation, decorating, home, garden, beauty, fashion, music, singing and dance. The learning process for physical activities-based classes differs dramatically from lecture-based educational classes. For example, participating in a series of interactive live webcam yoga classes is vastly different from passively listening to lectures for a series of interactive live webcam lecture classes on the topic of yoga. Teaching physical activities-based classes, via an interactive live webcam classroom environment, requires physical activity in coordination with live video and audio instruction. Electronic video and audio interaction controls as well as usability are critical to optimizing physical activities-based interactive live webcam classes.

### BRIEF SUMMARY

In accordance with embodiments, there are provided systems and methods for interactive live webcam physical activity classes. A system analyzes each live video stream of physical activity learning sent from web cams to the user interface for the webcam that sends a live video stream of physical activity instruction to the user interfaces for the web cams. For example, the system analyzes each live video stream of aerobics students practicing aerobic exercises that were sent from the aerobics students' computers' web cams to the aerobics instructor's computer that includes a webcam that the aerobics instructor uses to send a live video stream of aerobics instruction to the aerobics students' computers. The system sends the analysis of one of the live video stream of physical activity learning to a corresponding web cam. For example, the system sends individualized data for time spent on aerobics exercises and estimated calories burned to each of the aerobics students' computers. The system may also send the analysis of each of the live video streams of physical activity learning to the user interface for the webcam that sends the live video stream of physical activity instruction to enable sending of instructor feedback based on the analysis to the user interfaces for the web cams. For example, the system sends the aerobics students' individualized data for time spent on aerobics exercises and estimated calories burned to the aerobics instructor's computer so that the aerobics instructor may provide additional verbal encouragement and/or instruction to the aerobics students who the analysis indicates are lagging behind the other aerobics students.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 is an operational flow diagram illustrating a high level overview of a method for interactive live webcam physical activity classes in an embodiment; and

FIG. 2 is a screen shot illustrating a frame of an example user interface screen of a display device supporting methods for interactive live webcam physical activity classes.

### DETAILED DESCRIPTION

General Overview

Systems and methods are provided for interactive live webcam physical activity classes. Mechanisms and methods for interactive live webcam physical activity classes will be described with reference to example embodiments. The following detailed description will first describe a method for interactive live webcam physical activity classes. Next, a screen shot illustrating a frame of an example user interface screen is described.

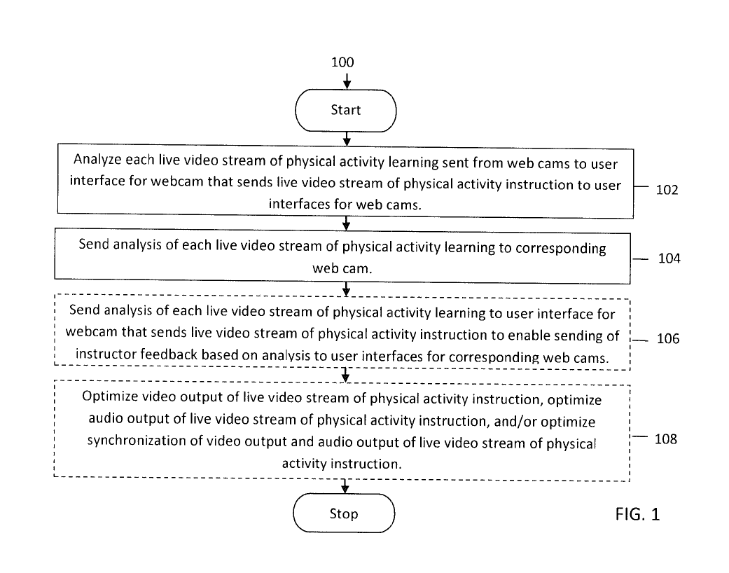

FIG. 1 is an operational flow diagram illustrating a high level overview of a method 100 for interactive live webcam physical activity classes. As shown in FIG. 1, a system can enable interactive live webcam classes for physical activities.

In block 102, each live video stream of physical activity learning sent from web cams to the user interface for the webcam that sends a live video stream of physical activity instruction to the user interfaces for the web cams is analyzed. For example, the system analyzes each live video stream of aerobics students practicing aerobic exercises that were sent from the aerobics students' computers' web cams to the aerobics instructor's computer that includes a webcam that the aerobics instructor uses to send a live video stream of aerobics instruction to the aerobics students' computers.

In block 104, analysis of each live video stream of physical activity learning is sent to the corresponding web cams. For example, the system sends individualized data for time spent on aerobics exercises and estimated calories burned to each of the aerobics students' computers. Computer analysis of physical activities is known in the art through systems such as Kinect®, a motion sensing input device by Microsoft® for the Xbox 360® video game console and Windows® personal computers.

Activities based webcam classes such as cooking, fitness, athletic, health, arts, crafts, do-it-yourself, renovation, decorating, home, garden, beauty, fashion, music, singing, and dance require activity specific instructional tools. The system may make an electronic timer and stop watch available to users. Users can use the timer interface and tool to track time for physical activities-based webcam classes. Timing tools and interfaces are available for all users and can be recorded for further feedback and instruction. Timing can be tracked with audio, video, and other user output and tasks. User timing and time records may provide a record and measure of actual physical activity. For fitness, athletic, and other physical activities, time can be measured and calculated with weight and other physical inputs to determine and track calories burned, distance traveled, and other performance measures. Users can access performance records and metrics in a dashboard interface, similar to a personal activity journal or activity log. Activity journals are managed by the system and users in coordination with classes taken and performance measures recorded during classes. Users can also select incentives to correspond to goals such as uploaded content, prizes, discounts, promotions, products, etc. The system can manage goals and reward completion of goals by distributing incentives. For user journals, users can record still images, videos, and audio, or upload content to supplement their performance and records. Users can also keep a scrap book or portfolio of work created from classes. For example, users can keep a scrap book, a portfolio of cakes made from cooking classes. Users can keep a record of video and audio from music lessons documenting their progress and performance over a series of classes. The system enables users to interact with other users' webcam content or recorded content in journals by providing an interface to draw, point, and/or sketch on other users' content or on other users' screens. This tool enables users to collaborate on content or allows users to draw attention to specific parts of the content.

In block 106, analysis of each of the live video streams of physical activity learning is optionally sent to the user interface for the webcam that sends the live video stream of physical activity instruction to enable sending of instructor feedback based on the analysis to the user interfaces for the web cams. For example, the system sends the aerobics students' individualized data for time spent on aerobics exercises and estimated calories burned to the aerobics instructor's computer so that the aerobics instructor may provide additional verbal encouragement and/or instruction to the aerobics students who the analysis indicates are lagging behind the other aerobics students.

Users can take a series of classes which will provide performance measures per each class for instructor and user feedback. Users can set goals and compare goals with other users. The system can track performance logs to rank and generate performance reports for comparison. Users can keep an interactive journal of class goals, notes and performance metrics for instructor and other feedback and interaction. Instructors can provide users with goals and feedback on journals as well as grade, rate, rank, check-off performance, and goals.

In block 108, video output of a live video stream of physical activity instruction is optionally optimized, audio output of a live video stream of physical activity instruction is optionally optimized, and/or synchronization of video output and audio output of a live video stream of physical activity instruction is optionally optimized. For example, the system electronically synchronizes a webcam class for singing or playing an instrument to a pre-recorded music video or music audio to start and play at the same time for all webcam students. Otherwise, students may experience playback latency that can result in students following along and singing or playing instruments at various times resulting in an unsynchronized and uncoordinated webcam class experience. For music webcam classes, the system provides users with an electronic metronome tool and interface to manage and control musical timing and rhythm. Electronic playback controls in tandem with timing controls can synchronize music and video playback for coordinating and synchronizing instruction. Playback synchronization and timing is managed by the system electronically. Users can interact with controls, settings, and preferences to select playlists and tracks, start, pause, and stop playback and synchronization as well as fine tune and adjust playback synchronization.

The system electronically manages the optimization of video and audio performance based upon the type of activity or category of class, bandwidth and internet speed, number of students in the class, rate of video and audio capture, and processing power. Physical activities-based classes include, but are not limited to cooking, fitness, athletic, health, arts, crafts, do-it-yourself, renovation, decorating, home, garden, beauty, fashion, music, singing and dance. Each type of class requires specific optimization management. Fitness, dancing, and athletic type classes require video optimization that captures motion clearly for users while synchronizing audio instruction. The system optimizes maximum video input, distribution, and output from various webcams and webcam types, frame rate and size, internet speed, and processing power to capture smooth, fluid movement at the largest viewing size without degrading the total broadcast. Furthermore, optional user settings and preferences can be manually adjusted by users to optimize, fine tune, and equalize video and audio performance.

Music and singing classes require audio optimization that captures and equalizes all sound qualities while synchronizing video instruction. The system manages video quality and processing power to increase audio quality on the fly and when needed. Maximum optimization boosts audio quality without noticeable loss of video quality and without loss in synchronization. The system manages the optimization of user audio input, distribution, and output from various microphones and personal computers by adjusting system performance. Audio quality for webcam video and personal computer microphones and speakers can lose high, low and midrange sounds during audio capture, recording, and distribution via internet and playback. The system controls and manages audio fidelity to reduce sound loss and to distribute the highest audio fidelity for various internet speeds and playback. Matching the timing of the audio to the video is critical for some physical activity classes. Typical to webcam video, audio can lag behind in timing of the video (or vice versa), negatively impacting the user experience and performance of music classes. Audio can also lag in time from user to user. The system manages and controls audio continuity by synchronizing the timing and playback of all audio sources to create a singular, unified audio experience for all users.

The method 100 may be repeated as desired. Although this disclosure describes the blocks 102-108 executing in a particular order, the blocks 102-108 may be executed in a different order.

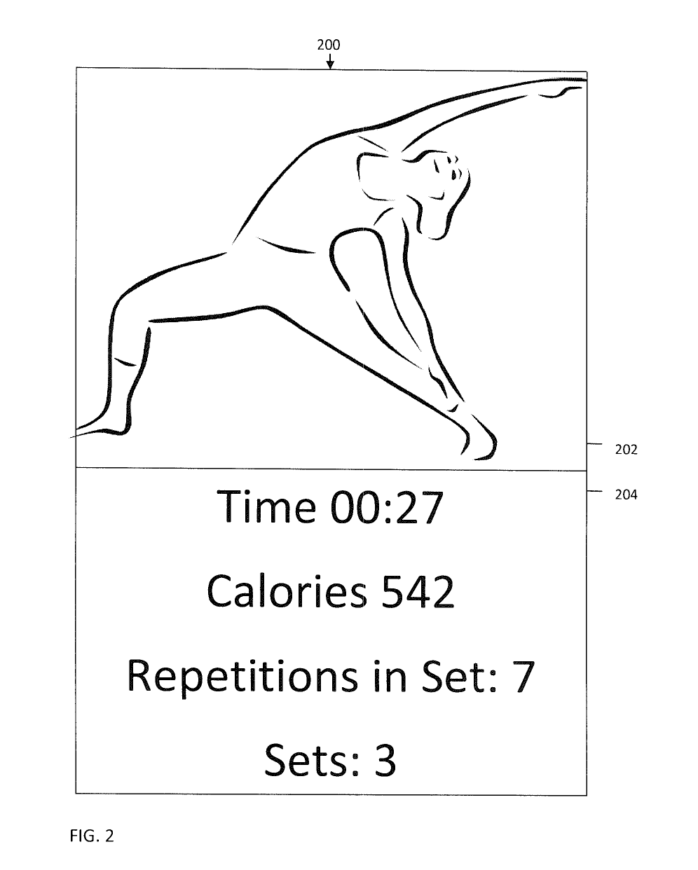

FIG. 2 is a screen shot illustrating a frame 200 of an example user interface screen of a display device for interactive live webcam physical activity classes in an embodiment. The frame 200 may include a video stream section 202 and a dashboard section 204. The video stream section 202 displays video streams depicting physical activities of other users, such as an aerobics instructor demonstrating an aerobics exercise or aerobics students practicing the aerobics exercises. The dashboard section 204 displays the analyzed metrics of physical activities, such as the individualized data for time spent on aerobics exercises and estimated calories burned for an aerobics student.

The frame 200 may be part of a larger display screen that includes fields for users to enter commands to create, retrieve, edit, and store records. The system may output a display screen that includes the frame 200 in response to a search based on search criteria input via a user interface. Because the frame 200 is a sample, the frame 200 could vary greatly in appearance. For example, the relative sizes and positioning of the text is not important to the practice of the present disclosure. The frame 200 can be depicted by any visual display, but is preferably depicted by a computer screen. The frame 200 could also be output as a report and printed or saved in electronic format, such as PDF. The frame 200 can be part of a personal computer system and/or a network, and operated from system data received by the network, and/or on the Internet. The frame 200 may be navigable by a user. Typically, a user can employ a touch screen input or a mouse input device to point-and-click to a location on the frame 200 to manage the text on the frame 200, such as a selection that enables a user to edit the text. Alternately, a user can employ directional indicators, or other input devices such as a keyboard. The text depicted by the frame 200 is an example, as the frame 200 may include a much greater amount of text. The frame 200 may also include fields in which a user can input textual information.

The system also provides features for class management. The system of class management for physical activities-based classes is a combination of user class management and electronic class management. Users can input class name, description, content, time, time zone, date, level of experience, skill, expertise, difficulty level, class capacity, category and type of class as well as price per class, payment information and contact information such as email, phone number and address. Users can also create an instructor profile and input instructor name, title, category of instruction, experience level, field of expertise and content about the instructor. All content for class and instructor inputs may upload or include links to sites, video, images, audio, downloadable materials, written instruction, and content. The system provides an easy to use interface to create, edit, and mange class and instructor inputs and content. Users can create multiple instructor profiles and classes. Users can create a branded “school” where an assigned user creates and manages a series of multiple classes taught by multiple instructors. Users can customize profile, class, school pages, and information by selecting pre-programmed templates and by adjusting color, layout, image and graphical settings. Classes can be created and all inputs and content can be edited when needed. Classes can also be canceled. When classes are canceled the system sends out cancellation messages to all students and electronically issues refunds on sales to students.

With these inputs and content, the system electronically manages and matches students to classes and instructors. Time and time zone are important inputs for scheduling online classes where instructors and students are located anywhere in the world. The system electronically matches and displays the correct time of class per student time zone. The system also manages class reminders and alerts to instructors and students based upon time and date. With level of experience and difficulty level inputs, the system can electronically rank and match class levels of difficulty and experience with student levels of difficulty and experience. The type or category of class enables electronic class categorization by the system, matching students with the appropriate types of classes and instructors. Prices of classes can also be categorized by the system, matching students with the appropriate class prices. Uploaded or links to class content or materials can be electronically distributed at pre-programmed times and or for additional cost. For example, sheet music for a music class can be released immediately after payment or after the first class. For a series of classes, class materials and content can be uploaded all at once and distributed to students before each class. The system can also make the materials available to instructors and students during the class in a separate view, window, link, or separate device.

The system electronically manages skill levels of instructors and students. Users can control the display of other users and user content by order of skill level or expertise via an interface control and settings. For users with multiple classes and for users who have created schools, the system can rank and match classes and expertise to students seeking specific skill levels, types, and categories of classes. The more classes an instructor offers, the more classes the instructor sells, the more classes socially ranked by students, the more positive comments and student feedback, the breadth of classes offered within the category or type of class, and the more experience the instructor gains, the higher the system will rank the instructor and her/his classes. Conversely, low ranking instructors and classes are the result of low quantity, breadth of classes offered, low sales of classes, low popularity, and/or negative student comments and feedback. Electronic management of ranking classes provides students and instructors feedback on quality, performance, and reliability of instructors and classes.

With all instructor inputs stored, the system provides a searchable and sortable user interface where students can easily choose, schedule and pay for classes. If students cannot find a class that fits their schedule or level of experience, they can request and submit to the system a class request. Requesting classes is very common amongst in-person physical activities-based classes, and offers an additional level of flexibility and scheduling for users. A class request can specify dates, times, time zone, type/category of class, capacity, instructor, contact information, and a further description of the request. The system processes the request to generate a class sales lead, sending to and alerting all instructors that meet the requirements of the request. Instructors can view and answer new student lead alerts. If a class request, or new student lead, generates a sale for the instructor, the system will log the conversion of the lead into a sale as a sales conversion. All requests, leads, and sales conversions are logged and tracked by the system for ranking instructor sales and sales lead conversions. Class requests and leads can also be viewed by instructors and students who are not actively using the system to manage and take classes.

The system also provides features for class controls. During an interactive live webcam class, the system provides the instructor with an interface with tools and controls for teaching a class with multiple students. View controls allow users to view multiple students simultaneously. With microphone and webcam controls, users can control audio and video input sources. By controlling audio input, audio volume, and muting, instructors can control what students hear and when. By controlling video input, instructors can control what students see and when. Controls are selective and can control audio and video for all students or individual students. Controls can select from different or multiple video, audio, or content input sources. Controls can be available to users in a dashboard, settings or preferences format; similar to different channels on a television broadcast mixing board. For example, a music instructor can mute all student audio to prevent audio interference and feedback to demonstrate a musical technique while also displaying sheet music and a close up view of her/his musical instrument. In another example, a cooking instructor can display still images of packaged ingredients, the finished dish while showing various videos and webcam views of cooking preparation and cooking. Multiple instructors or channels of instruction can be controlled by users. For example, for large webcam classes, several teachers can teach in tandem to optimize instruction. Users can also control messages, advertisements, promotions, and paid content. Large webcam classes with many students in attendance can be viewed as images with student names. Instructors can navigate and select students by voice, touch, keyboard, mouse, remote device control, or by calling out names of students to enable webcam, audio, video, content interaction. A large part of physical activities-based webcam instruction involves individual interaction by the instructor with students. For webcam classes with many student users, the system provides instructors with electronically optimized webcam feeds and interface to view multiple students at once. System optimization of multiple student webcam views maximizes webcam view size, quality, and quantity by managing video and audio quality, internet speed, bandwidth, number of views, size, and dimension of views and type of class activity. The user interface and controls to view multiple students allow users to manually adjust and fine tune optimization settings and preferences. Instructors can control attendance by kicking or ejecting students out of a class. This control boots the student from the online class and stops the student user from further participation in the class.

In an in-person classroom environment, students will raise their hand to gain the attention of the instructor to ask a question. To gain the attention of the instructor in a webcam class, the system will display a hand icon, blinking or flashing hand icon, or animated hand icon as a graphical alert notifying the instructor that the student has a question for the instructor. This alert is user controlled. With a mouse, touch or track pad, or touch screen interface, students can click a button labeled “Raise Hand,” with the button possibly including an icon, image or graphical representation of a hand. A graphical hand icon may be displayed next to or as part of a student's name or image or webcam view. Instructors can click the hand or corresponding student to see and hear and address their question. Questions can also be integrated into a messaging or chat board tied to the hand raise icon and hand raising interaction. Clicking, selecting, or touching the raised hand icon on display can cancel and turn off the function. Additional controls can limit the amount of raised hands per student and block a student from raising a hand. Time limitations and settings can be selected to limit or time the use and display of hand raises. Levels of urgency can be selected and displayed as well. For example, a flashing red hand is urgent, orange or yellow hand is not so urgent, and green is low priority. Students who have their hands raised can be sorted into an order of priority, urgency, level of difficulty, and/or chronologically.

To manage classes efficiently, instructors can control the start and end of classes. When creating a new class, instructors input start time and end time of a class as well as the time zone. With online classes, instructors and students may teach and take classes from anywhere in the world, therefore the system can calculate and display the correct time in each time zone for each student so everyone who joins the class will start at the same time. Classes are timed from the start of the class to the end. Instructors start classes by clicking the start button on their class management dashboard initiating the webcam class and starting the timing of the class. Manual starting of the webcam class by each student and instructor is tracked by the system. By tracking video, audio, and class timing of each individual user, the system can manage and optimize synchronization, latency, speed and performance of the class experience. Class time is also tracked for financial and performance metrics, and analysis for instructor, students and administration. Class timing can be shown as a clock, as a countdown, or count up. As the scheduled class time expires, an “End Class” button control may appear. By clicking, touching, or selecting the “End Class” button, the instructor stops webcam, video, audio and all content and closes the class application. By providing manual user controls for ending of the class, the system can display feedback, surveys, and sharing tools for students to share content with other students and friends. A combination of user and system controls can manage and limit the number of students that can interact in the class via webcam and which can interact with audio and messaging only. For example, for a large webcam class with hundreds of students in attendance, the system can manage webcam interaction for up to 25 or more students at the time while providing audio interaction and chat messaging for the rest of the students.

The system also provides features for financial management of webcam classes. Most physical activities-based classes and instruction are owned and operated by individuals or small businesses. However, many prior art webcam systems do not provide tools or systems to assist instructors with the marketing, sales and financial management of their classes. The system provides instructors and users with electronic financial and marketing management of classes by providing students with an interface to purchase and pay for classes. The system processes and collects payments by students on behalf of instructors. The system also distributes payment monies to instructors by transferring funds to instructor designated banking accounts. The system provides instructors with a dashboard interface for managing sales transactions and transfer of payments and funds from sales of classes.

The system records and tracks class sales, offering users a financial management dashboard interface and tools for accounting, and analyzing and reporting class sales, sales performance and conversion of marketing and sales promotions. By tracking sales performance, the system can provide instructors with information such as their top selling classes, top paying students and customers, top paying time slots, top paying time zones and geographic areas such as zip code, city, state and country, top selling types of classes, top selling instructors, and top selling promotions. The system can generate marketing and promotional offers to students. With a dashboard interface, instructors can access the financial management system to create marketing codes, promotional codes and offers, discounts, gift codes, pre-pay offers, class series offers, bundled offers, co-branded offers, product offers, subscriptions and membership offers. With the dashboard, instructors can create marketing and promotional offers by inputting and adjusting preferences to generate offers that are limited in price, time, location, quantity, use, and other options. If students are not happy with classes or request a refund, the system provides an interface to issue full or partial refunds to students, transferring money from designated instructor accounts to student accounts.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. An apparatus for interactive live webcam physical activity classes, the apparatus comprising:
a processor; and
one or more stored sequences of instructions which, when executed by the processor, cause the processor to carry out the steps of:
analyzing each of a plurality of live video streams of physical activity learning sent from a corresponding plurality of web cams to a user interface, wherein the user interface is associated with a webcam that sends a live video stream of physical activity instruction to a plurality of user interfaces associated with the corresponding plurality of web cams; and
sending the analysis of one of the plurality of live video streams of physical activity learning to a corresponding one of the plurality of web cams.

2. The apparatus of claim 1, wherein the corresponding one of the plurality of web cams receives the analysis of a corresponding one of the plurality of live video streams of physical activity learning concurrent with receiving the live video stream of physical activity instruction.

3. The apparatus of claim 1, wherein the corresponding one of the plurality of web cams receives the analysis of a corresponding one of the plurality of live video streams of physical activity learning subsequent to receiving the live video stream of physical activity instruction.

4. The apparatus of claim 1, further comprising sending the analysis of one of the plurality of live video streams of physical activity learning to the user interface associated with the webcam that sends the live video stream of physical activity instruction to enable sending of instructor feedback based on the analysis to a corresponding one of the plurality of user interfaces associated with the corresponding one of the plurality of web cams.

5. The apparatus of claim 1, further comprising at least one of optimizing the video output of the live video stream of physical activity instruction, optimizing the audio output of the live video stream of physical activity instruction, and optimizing the synchronization of the video output and the audio output of the live video stream of physical activity instruction.

6. A machine-readable medium carrying one or more sequences of instructions for interactive live webcam physical activity classes, which instructions, when executed by one or more processors, cause the one or more processors to carry out the steps of:
analyzing each of a plurality of live video streams of physical activity learning sent from a corresponding plurality of web cams to a user interface, wherein the user interface is associated with a webcam that sends a live video stream of physical activity instruction to a plurality of user interfaces associated with the corresponding plurality of web cams; and
sending the analysis of one of the plurality of live video streams of physical activity learning to a corresponding one of the plurality of web cams.

7. The machine-readable medium of claim 6, wherein the one of the corresponding plurality of web cams receives the analysis of the corresponding one of the plurality of live video streams of physical activity learning concurrent with receiving the live video stream of physical activity instruction.

8. The machine-readable medium of claim 6, wherein the one of the corresponding plurality of web cams receives the analysis of the corresponding one of the plurality of live video streams of physical activity learning subsequent to receiving the live video stream of physical activity instruction.

9. The machine-readable medium of claim 6, further comprising the step of sending the analysis of the one of the plurality of live video streams of physical activity learning to the user interface associated with the webcam that sends the live video stream of physical activity instruction to enable sending of instructor feedback based on the analysis to a corresponding one of the plurality of user interfaces associated with the corresponding one of the plurality of web cams.

10. The machine-readable medium of claim 6, further comprising the step of at least one of optimizing the video output of the live video stream of physical activity instruction, optimizing the audio output of the live video stream of physical activity instruction, and optimizing the synchronization of the video output and the audio output of the live video stream of physical activity instruction.

11. A method for interactive live webcam physical activity classes, the method comprising:
analyzing each of a plurality of live video streams of physical activity learning sent from a corresponding plurality of web cams to a user interface, wherein the user interface is associated with a webcam that sends a live video stream of physical activity instruction to a plurality of user interfaces associated with the corresponding plurality of web cams; and
sending the analysis of one of the plurality of live video streams of physical activity learning to a corresponding one of the plurality of web cams.

12. The method of claim 11, wherein the one of the corresponding plurality of web cams receives the analysis of the corresponding one of the plurality of live video streams of physical activity learning concurrent with receiving the live video stream of physical activity instruction.

13. The method of claim 11, wherein the one of the corresponding plurality of web cams receives the analysis of the corresponding one of the plurality of live video streams of physical activity learning subsequent to receiving the live video stream of physical activity instruction.

14. The method of claim 11, further comprising sending the analysis of the one of the plurality of live video streams of physical activity learning to the user interface associated with the webcam that sends the live video stream of physical activity instruction to enable sending of instructor feedback based on the analysis to a corresponding one of the plurality of user interfaces associated with the corresponding one of the plurality of web cams.

15. The method of claim 11, further comprising at least one of optimizing the video output of the live video stream of physical activity instruction, optimizing the audio output of the live video stream of physical activity instruction, and optimizing the synchronization of the video output and the audio output of the live video stream of physical activity instruction.

16. A method for transmitting code for interactive live webcam physical activity classes, the method comprising
transmitting code to analyze each of a plurality of live video streams of physical activity learning sent from a corresponding plurality of web cams to a user interface, wherein the user interface is associated with a webcam that sends a live video stream of physical activity instruction to a plurality of user interfaces associated with the corresponding plurality of web cams; and
transmitting code to send the analysis of one of the plurality of live video streams of physical activity learning to a corresponding one of the plurality of web cams.

17. The method for transmitting code of claim 16, wherein the one of of the corresponding plurality of web cams receives the analysis of the corresponding one of the plurality of live video streams of physical activity learning concurrent with receiving the live video stream of physical activity instruction.

18. The method for transmitting code of claim 16, wherein the one of the corresponding plurality of web cams receives the analysis of the corresponding one of the plurality of live video streams of physical activity learning subsequent to receiving the live video stream of physical activity instruction.

19. The method for transmitting code of claim 16, further comprising transmitting code to send the analysis of the one of the plurality of live video streams of physical activity learning to the user interface associated with the webcam that sends the live video stream of physical activity instruction to enable sending of instructor feedback based on the analysis to a corresponding one of the plurality of user interfaces associated with the corresponding one of the plurality of web cams.

20. The method for transmitting code of claim 16, further comprising transmitting code to at least one of optimize the video output of the live video stream of physical activity instruction, optimize the audio output of the live video stream of physical activity instruction, and optimize the synchronization of the video output and the audio output of the live video stream of physical activity instruction.
